(19) United States
(12) Patent Application Publication
(10) Pub. No.: US 2011/0242582 A1
(43) Pub. Date: Oct. 6, 2011

(54) PRINTER CONTROL SYSTEM, PRINTING METHOD, AND STORAGE MEDIUM

(75) Inventors: Charles Thomas Armstrong, Irvine, CA (US); Chihsin Steven Young, Irvine, CA (US)

(73) Assignee: CANON KABUSHIKI KAISHA, Tokyo (JP)

(21) Appl. No.: 12/751,959

(22) Filed: Mar. 31, 2010

(51) Int. Cl. G06F 15/00

(52) U.S. Cl. 358/1.15

(57) ABSTRACT

A method for controlling a printer via a server computer comprises, spooling a file including a hierarchy of a print ticket attached with a fixed document and a fixed page, in response to a print job on a client computer, creating print data from a spooled file, processing a print job, storing, using a CPU, a copy of the spooled file during the processing of the print job, receiving a request to redirect, and sending a modified copy of the spool file to another printer after the request to redirect is received.

### BACKGROUND OF THE INVENTION

1. Field of the Invention

The present invention relates to a printer control system that redirect a print job when an error occurs.

2. Description of the Related Art

In a conventional printing system, an information processing apparatus, such as PC, and an image forming apparatus, such as a printer, communicate with each other to process a print job. However, if a print job is failed due to device faults (paper jam, out of paper/ink, etc.) there was not a sufficient solution for the fault.

For example, it was impossible to sufficiently and accurately detect print errors on specific page during n-up/duplex printing modes and reformatting print job based on the error condition on specific page on above said modes.

For example, if 20 page documents in total are being printed with 2-up and duplex mode, and if an error occurred at 3rd physical page, now, job must be reformatted from 9th logical page, but there was not a proper solution.

It was also unable to sufficiently and properly handle all the stapling features, for example, if a Single print job consists of 3 documents, and print intent was to staple on each document, and if an error occurred on the second document, remaining pages in the second document should not be stapled, but the third document should be stapled.

However, there was not a proper solution to realize it.

In addition, if an error occurs on 90th page in 100 pages print job, the redirect job is too heavy to efficiently redirect them.

Another problem in the prior art was, if an error happens during redirecting spooled file, while the printing system is working with CSR (client side rendering) under client-server printing environment, it is impossible to redirect the print data to printers of different types.

This is because, the client driver creates RAW data from the spooled, for example, XPS format file and if an error happens in the printer, the RAW data will be sent to the server and the original spooled XPS format file is deleted once the print job is sent to a server.

### SUMMARY OF THE INVENTION

Exemplary embodiments of the present invention are directed to a system capable of redirecting a failed print job to other printers with efficiently and practically.

According to an aspect of the present invention, a method for controlling a printer via a server computer comprises; spooling a file including a hierarchy of a print ticket attached with a fixed document and a fixed page, in response to a print job on a client computer, creating print data from a spooled file, processing a print job, storing, using a CPU, a copy of the spooled file during the processing of the print job, receiving a request to redirect, and sending a modified copy of the spool file to another printer after the request to redirect is received.

Another aspect of the present invention is that the spooled file is created in an XPS format.

Still another aspect of the present invention is that the copy of the spooled file is modified based on the information about the page where an error occurred.

Still another aspect of the present invention is that method for controlling a printer via a server computer comprises; spooling a file including a hierarchy of a print ticket attached with a fixed document and a fixed page, in response to a print job on a client computer, creating print data from a spooled file, processing a print job, storing, using a CPU, a copy of the spooled file during the processing of the print job, receiving a request to redirect, sending a modified copy of the spooled file to another printer after the request to redirect is received, and deleting the copy of the spooled file if a signal which corresponds to a predetermined redirect printing operation is not received.

Another aspect of the present invention is that the method further comprises, receiving a request to redirect, sending the local copy of the spooled file to another printer if the request to redirect is received.

Another aspect of the present invention is that system for controlling a printer via a server computer comprises; spooler for spooling a file including a hierarchy of a print ticket attached with a fixed document and a fixed page, in response to a print job on a client computer, rendering unit for creating print data from a spooled file, processing unit for processing a print job, storing unit for storing a copy of the spooled file during the processing of the print job, receiving unit for receiving a request to redirect, and sending unit for sending a modified copy of the spooled file to another printer in response to the request to redirect.

Another aspect of the present invention is that when modifying the spooled file, the method modifies a print ticket data included in the spooled file depending on the printing error.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments and features of the invention and, together with the description, serve to explain at least some of the principles of the invention.

FIG. 1 is a block diagram illustrating an example of a printing system according to an exemplary embodiment.

FIG. 2 illustrates driver functions performed by a printer according to an exemplary embodiment.

FIG. 3 illustrates a flowchart showing redirecting process performed by a printer according to an exemplary embodiment.

FIG. 4 illustrates a detailed flow chart for showing a redirection process according to an exemplary embodiment.

FIG. 5 illustrates a detailed flow chart for showing a redirection process according to another exemplary embodiment.

FIG. 6 is a flowchart illustrating an example procedure of job modification processing that can be performed by the printer according to an exemplary embodiment.

FIG. 7 is a flowchart illustrating an example procedure of FindFDFP that can be performed by the image forming apparatus according to an exemplary embodiment.

FIG. 8 is a flowchart illustrating an example procedure of ModifyFDS(1) that can be performed by the printer according to an exemplary embodiment.

FIG. 9 is a flowchart illustrating an example procedure of ModifyFDS(2) that can be performed by the printer according to an exemplary embodiment.

FIG. 10 illustrates examples of LayoutDOM according to an exemplary embodiment.

FIG. 11 illustrates examples of XPS DOM according to an exemplary embodiment.

FIG. 12 illustrates examples of structure of FDS according to an exemplary embodiment.

FIG. 13 illustrates examples of modified XPS file structure according to an exemplary embodiment.

FIG. 14 illustrates a UI applicable to the printer or client computer according to an exemplary embodiment.

FIG. 15 illustrates another UI applicable to the printer or client computer according to an exemplary embodiment.

FIG. 16 illustrates another UI applicable to the printer or client computer according to an exemplary embodiment.

FIG. 17 illustrates a detailed flow chart for showing a redirection process according to another exemplary embodiment.

FIG. 18 illustrates a detailed flow chart for showing a redirection process according to another exemplary embodiment.

FIG. 19 illustrates a flow chart for deleting XPS print data according to an exemplary embodiment.

FIG. 20 illustrates a flow chart for deleting XPS print data according to another exemplary embodiment.

FIG. 21 illustrates a flow chart for deleting XPS print data according to another exemplary embodiment.

FIG. 22 illustrates a flow chart for deleting XPS print data according to another exemplary embodiment.

### DETAILED DESCRIPTION OF THE EMBODIMENTS

The following description of exemplary embodiments is illustrative in nature and is in no way intended to limit the invention, its application, or uses. It is noted that throughout the specification, similar reference numerals and letters refer to similar items in the following figures, and thus once an item is described in one figure, it may not be discussed for following figures. Various exemplary embodiments, features, and aspects of the invention will be described in detail below with reference to the drawings.

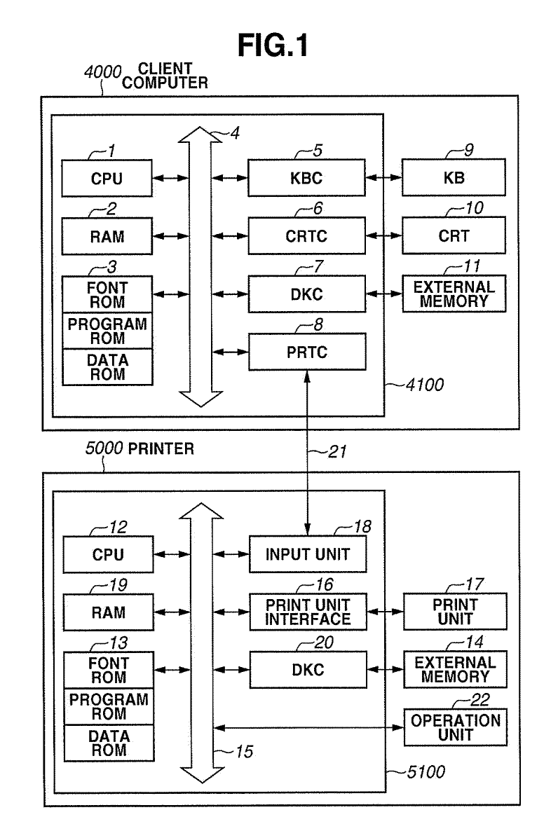

FIG. 1 is a block diagram showing the structure of a printer system according to an embodiment of the present invention. When the functions of the present invention are implemented, the present invention can be applied to a single unit, to a system formed of a plurality of units, and also to a system executing processing with a connection through a network, such as a local area network (LAN) and a wide area network (WAN).

In the following embodiments, explained is a driver based redirect printing solution. It handles interleaved or non-interleaved XPS format document with various job and document print type information such as: Collate, non-collate, job copy, document copy, duplex, n-up (JobNUpAllDocumentsContiguously, DocumentNUp), Booklet, reverse printing, etc. When spooled XPS job is interleaved, it redirects the remaining job as soon as error occurred (redirects even while spooling).

In FIG. 1, a client computer 4000 is provided with a central processing unit (CPU) 1 for executing document processing for documents having figures, images, characters, and tables (including table calculation), according to a document processing program stored in the program ROM of a ROM 3 or in an external memory 11. In the following embodiments, the CPU could include a microprocessor. The CPU 1 controls each device connected to a system bus 4. An operating system program (hereinafter called an OS), which is the control program of the CPU 1, is stored in the program ROM of the ROM 3 or in the external memory 11. Font data used for the document processing is stored in the font ROM of the ROM 3 or in the external memory 11. Various types of data used in the document processing is stored in the data ROM of the ROM 3 or in the external memory 1. A RAM 2 serves as the main memory and work area of the CPU 1.

A keyboard controller (KBC) 5 controls key inputs sent from a keyboard 9 and a pointing device (not shown). A CRT controller (CRTC) 6 controls a display device 10, which includes LCD, OLED, or other types of displays. A disk controller (DKC) 7 controls access to the external memory 11, such as a Flash Memory, hard disk (HD) and a floppy disk (FD), which stores a boot program, various application programs, font data, user files, edit files, and a printer-control-command generating program (hereinafter called a printer driver). A printer controller (PRTC) 8 is connected to a printer 5000 through a bi-directional interface 21 and executes communication control processing with the printer 5000.

The CPU 1 executes developing (rasterizing) processing of outlined fonts, for example, on a display information RAM specified on the RAM 2 to allow what-you-see-is-what-you-get (WYSIWYG) display on the display device 10. The CPU 1 also opens various recorded windows according to commands specified by a mouse cursor (not shown) and executes various types of data processing. When the user executes printing, the user can open a window for printing settings to specify a printing processing method for a printer driver, such as printer settings and printing mode selection.

The printer 5000 is controlled by a printer CPU 12. The printer CPU 12 outputs an image signal serving as output information to a printing unit section (printer engine) 17 connected to a system bus 15, according to a control program stored in the program ROM of a ROM 13 or a control program stored in an external memory 14. The program ROM of the ROM 13 stores the control program of the printer CPU 12.

A printer driver, which is capable of generating print information that may be output to the printer, can be installed on the external memory 11 according to a print request from an application. The printer driver according to the present exemplary embodiment has a function for outputting a structured job having an XML Paper Specification (i.e., XPS) format to the printer. An application can be configured to have a function for outputting a structured job to the printer.

Font data used to generate the output information is stored in the font ROM of the ROM 13. Information used in the host computer is stored in the data ROM of the ROM 13 when the printer is not provided with the external memory 14, such as a hard disk. The printer CPU 12 can execute communication processing with the client computer through an input unit section 18 to report printer information to the client computer 4000. RAM 19 functions as the main memory and the work area of the printer CPU 12, and its memory capacity can be extended by an optional RAM connected to an extension port (not shown). The RAM 19 is used for an output-information developing area and an environmental-data storage area, and serves as a non-volatile RAM (NVRAM). An access to the external memory 14, such as a hard disk or an IC card, is controlled by a memory controller (DKC) 20. The external memory 14 is connected as an option, and stores font data, an emulation program, and form data. An operation section 5100 is provided with a switch and an LED display for operations.

As the external memory 14, not only one device but also a plurality of devices may be provided. A plurality of optional cards having external fonts may be connected to increase fonts in addition to the built-in fonts stored in the font ROM, or a plurality of external memories, which store programs for interpreting different printer control languages may be connected. An NVRAM (not shown) may be provided to store printer-mode setting information sent from the operation section 5100.

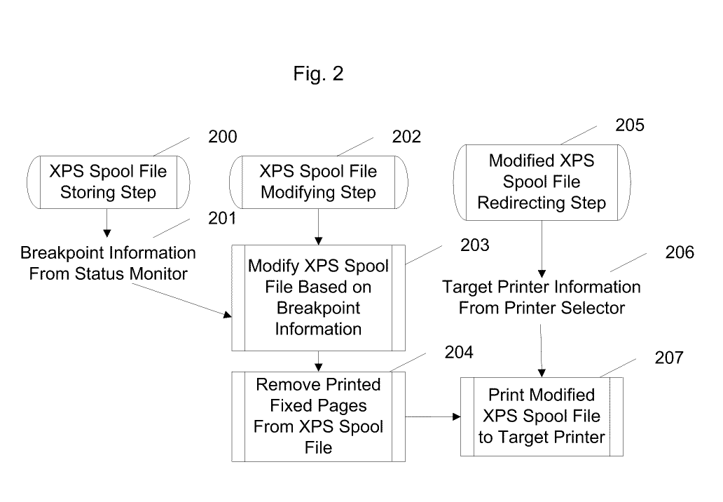

FIG. 2 illustrates driver functions performed by the printer according to an exemplary embodiment.

In FIG. 2, 200 denotes a XPS spool file storing step, where XPS spool file sent from an application in the client computer is saved in the RAM 19. Step 202 denotes a XPS spool file modifying step, where XPS spool file is modified if a printer error arises. If printer error arises during the XPS spool file storing step, a status monitor will notify breakpoint information, then the XPS spool file modifying step modifies XPS spool file based on the breakpoint information in Step 203.

Then in Step 204, the XPS spool file modifying step removes already printed fixed pages from XPS Spool file. Step 205 denotes modified XPS spool file redirecting step, where redirecting the print job to a selected alternative printer is carried out. Step 206 denotes obtaining step for obtaining information on a target printer, which is selected by a printer selector. Step 207 denotes a step for sending modified XPS spool file to the target printer.

As shown in FIG. 2, in this embodiment, XPS driver has a unique redirecting filter which serializes the original document to a memory as soon as each part has been received. When an error occurred, a status monitor is notified by the printing device through a language monitor and redirecting application is launched with print data storage details and physical page number where the error occurred. The redirecting application uses this information to retrieve the XPS document while it is spooling and Job modification process modifies the XPS document to remove the printed pages to be print on a newly selected printing device.

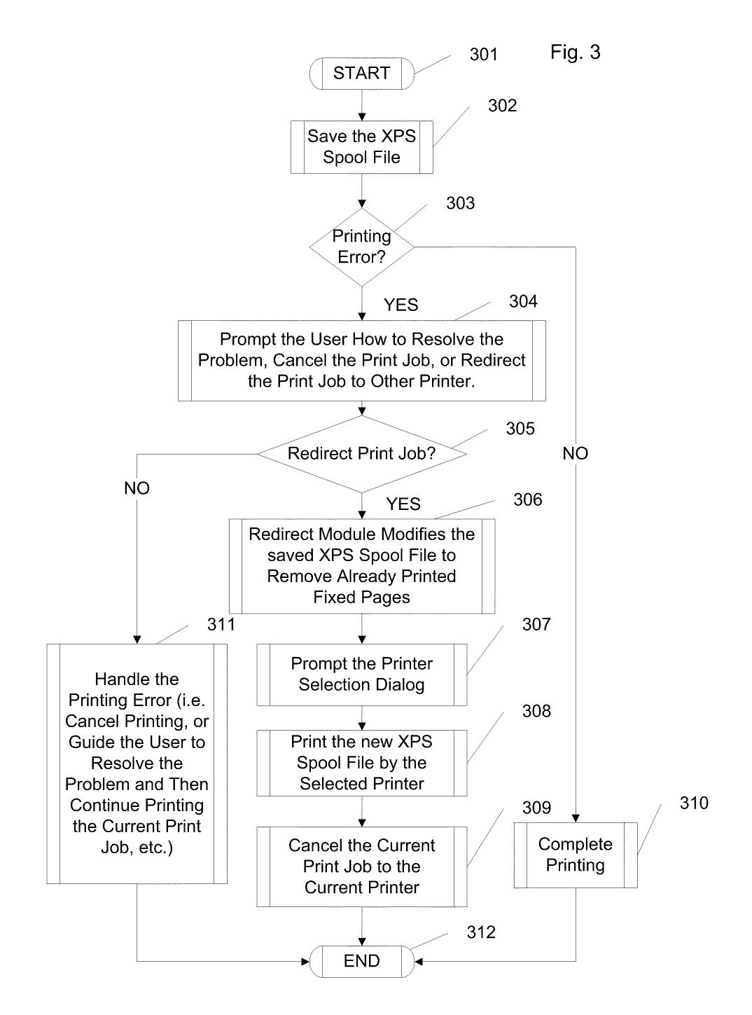

FIG. 3 illustrates a flowchart showing redirecting process performed by the printer according to an exemplary embodiment.

In FIG. 3, starting from Step 301, in Step 302, XPS data sent from the client computer is spooled and saved as an XPS Spool File by redirect filter in the RAM 19. During the spooling, printing is also started. Here, the spooled XPS format file includes a hierarchy of a print ticket attached with a fixed document and a fixed page, in response to a print job.

Next in Step 303, during the printing, if an error occurred, a Status monitor, which is explained later, is notified the error by the printing device through a language monitor, which is explained later, then proceeding to Step 304.

In Step 304, the CPU 1 of the client computer drives the display device 10 to prompt the User how to resolve the problem, cancel the print job, or redirect the print job to the other printer.

In Step 305, if User selects the redirect the print job, In Step 306, Redirect Module (a redirecting application) stored in the ROM 3, which is explained later, is launched and with the print data details and physical page number where the error occurred, the redirecting application retrieves the XPS document data 420, or in other words, the XPS document data 420 is sent to the redirecting application. And the redirection application modifies the saved XPS spool file to remove the already printed fixed pages and to print remaining pages with the newly selected printer. Then, through CPU 1 drives the display device 10 to prompt the user to select an alternative printer.

Then in Step 308, printing of the new XPS file is carried out by the selected alternative printer. In Step 309, the CPU 1 cancels the current print job to the current printer. Then the program proceeds to Step 312 to end the redirecting flow.

In Step 303, if there is not any error, then program proceeds to Step 312. If in Step 305, user does not select to redirect print job, then in Step 311, alternative process may be carried out. The alternative process may include cancelling printing, prompting user to resolve the problem, such as paper jams or ink shortage, etc. and then continue printing the current print job, etc.

After Step 311, the program proceeds to a Step 312 to finish the flow.

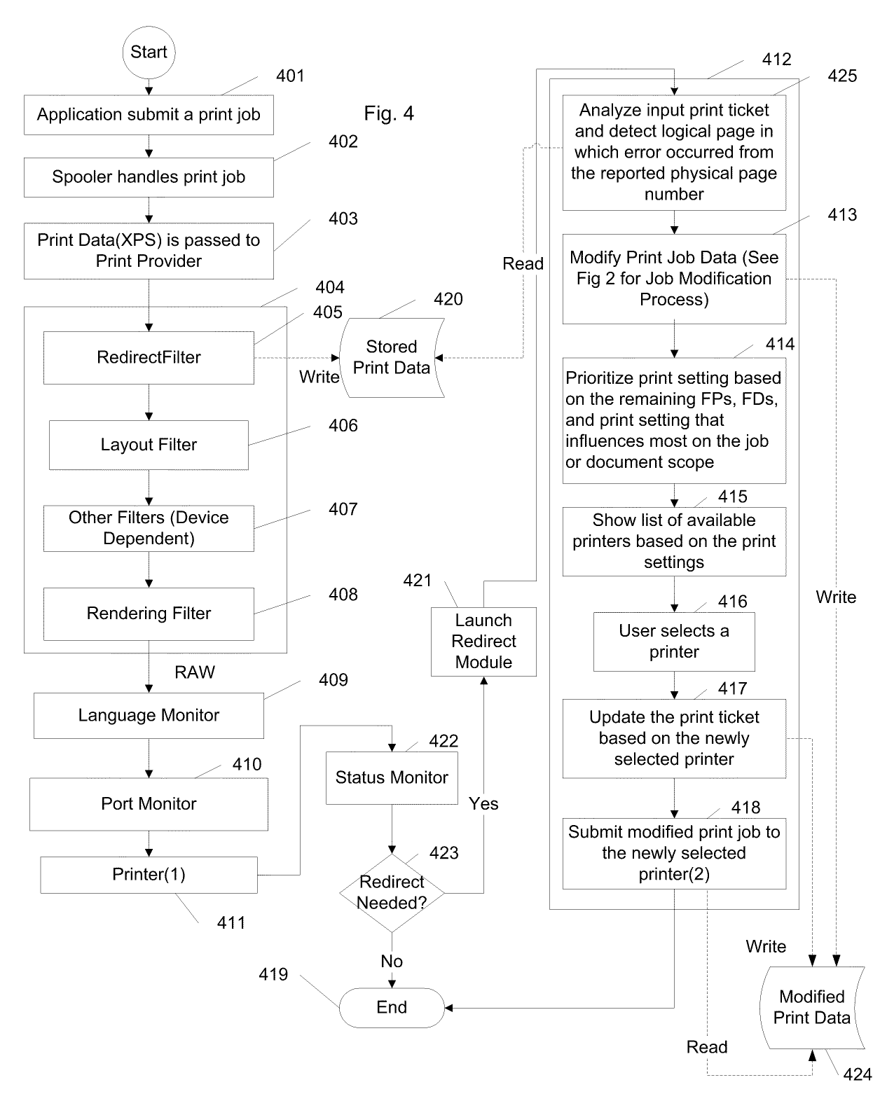

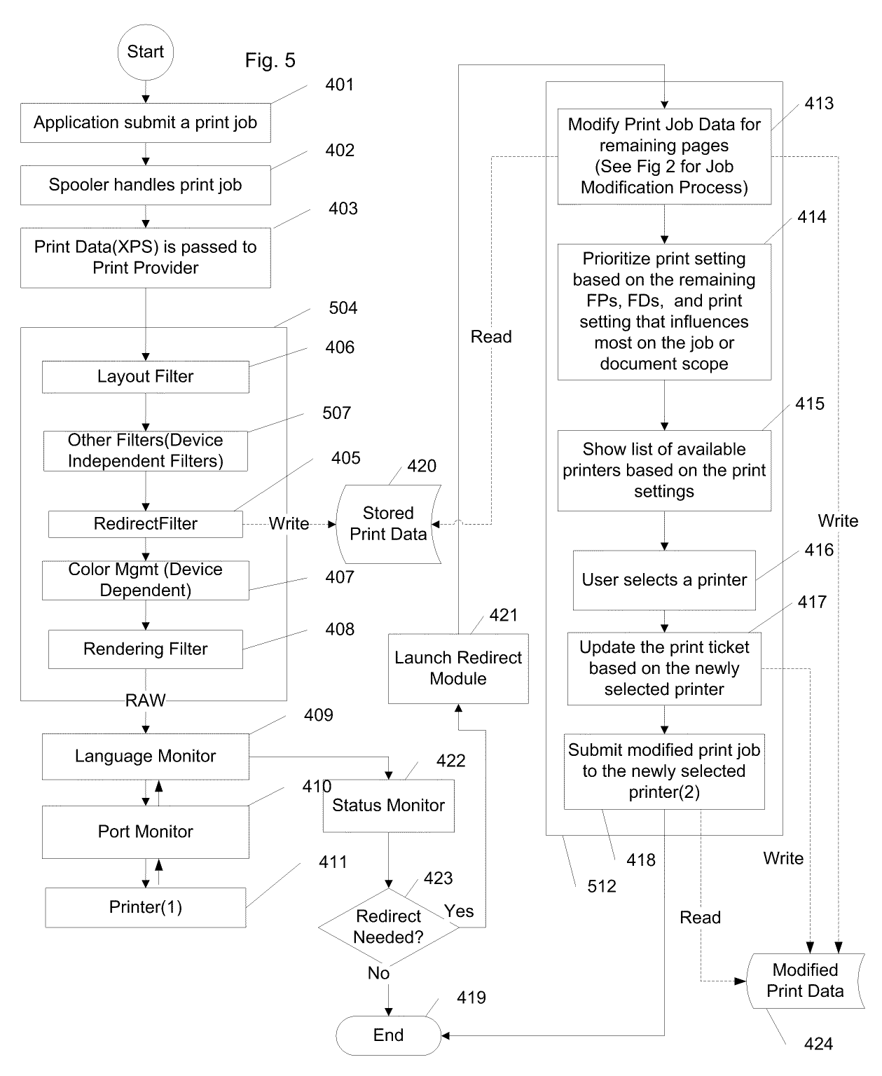

FIG. 4 illustrates a detailed flow chart where the redirecting filter is arranged before a layout filter. Here, position of the redirecting filter plays major role in the job modification process. It can be placed in either before the layout filter (as in FIG. 4) or after the layout filter and before the device specific filter (such as color management filter) as explained later with FIG. 5.

When redirecting filter is placed before the layout filter, the redirecting application must remove the fixed pages that are printed successfully, it may not be straightforward as in conventional spooled data where it contains only printable pages in XPS document, wherein it can have multiple Fixed Documents with various settings along with job settings.

In FIG. 4, in Step 401, client application submits a print job and in Step 402, a spooler in the PROGRAM ROM 3 of the client computer 4000 starts handling the print job with CPU 1. In Step 403, the XPS print date is passed to a print provider, which is also in the PROGRAM ROM 3.

In Step 404, the print job data is processed by a print filter pipeline, where 404 comprises a redirect filter Step 405 for copying the spooled XPS file and for writing it in the RAM 19, a layout filter Step 406 for creating a layout of pages, other filter Step 407, which are device dependent, such as for watermark adding filter, color management filter, etc., and a rendering filter Step 408 for converting the XPS format data to RAW data, which is device dependent.

The RAW data from the rendering filter Step 408 is supplied to a language monitor, which provides the common language needed for the client and printer to understand each other in bidirectional communication, so configuration can be done for the printer and monitor printer status.

Step 410 denotes a port monitor and 411 denotes printer. Step 412 denotes a redirect module, which includes Step 425 for detecting logical page, Step 413 for modifying print job data, Step 414 for prioritizing print setting, Step 415 for showing list of available printer based on the print setting, Step 416 for prompting user to select printer, Step 417 for modifying the print ticket based on the capability of the newly selected printer, and Step 418 for submitting modified print job to the newly selected printer.

In this embodiment, the modification is carried out by using a CPU 1 together with a program stored in the ROM 3 in the client computer 4000, but if the redirect module is in the server side computer, then the modification is carried out by using a CPU together with a program stored in a memory in the server computer.

Step 419 denotes the end of the flow. 420 denotes an XPS print data which is stored in the RAM 2 during the spooling and/or rendering the XPS print data to RAW data, Step 421 denotes a step for launching redirect module 412, Step 422 denotes status monitor, Step 423 denotes a step for detecting whether redirect is needed or not and if needed for sending a request to start redirect printing to Step 421, and Step 424 denotes a modified print data.

As shown in FIG. 4, while the redirect filter Step 405 writes stored print data in the RAM 2, if the language monitor in Step 409 detects a printing error, such as paper jam, ink shortage, etc. then the status monitor in Step 422 notifies that to Step 423. If Step 423 does not detect that redirection is needed, then the program ends.

If Step 423 detects there is a device fault so that the redirection is needed, then Step 421 launches the redirect module 412. In the redirect module 412, Step 425 reads the stored XPS print data 420 to analyze input print ticket, which includes printing type information, such as: Collate, non-collate, job copy, document copy, duplex, n-up (JobNUpAllDocumentsContiguously,DocumentNUp), Booklet, reverse printing, etc. and detect a logical page in which the error occurred from the reported physical page number.

Then in Step 413, the spooled print data 420 is modified based on the information, whether the printing type is at least one of a duplex printing, n-up printing, whether whole job or document is collated or non-collated with copy count, job copy, document copy, Booklet, reverse printing, etc. and on which page the error occurred. However, Step 413 does not modify the spooled XPS format file based on a stapling requirement, which is one of the aspects of this embodiment.

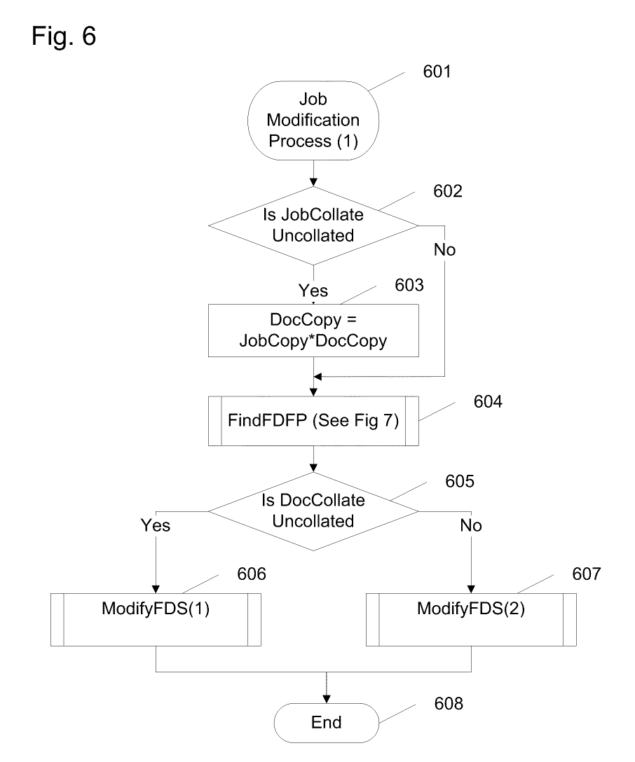

These will be briefly explained in FIG. 6 later, then the modified print job data 424 is written in the RAM 2. In Step 414, print setting is prioritized based on the remaining FDs (Fixed Documents), FPs (Fixed Pages) and print setting that influence most on the job or document scope.

Then in Step 415, CPU 1 determines required printing features for the print job based on the print ticket in the spooled file, and drives display device 10 to show a list of available candidate printers based on the printing features. Then in Step 416, CPU 1 prompts a user to select printer, so that at least one of the candidate printers is selected for redirection.

In alternative embodiment, in Step 416, if the user selection is not obtained within a predetermined period after Step 415, then the nearest printer in the list can be automatically selected by the CPU.

In this embodiment, if a user does not select a redirect printer within a predetermined period, then the CPU 1 automatically select one of the printers in the list created in Step 415. The automatically selected printer could be the nearest printer or the most frequently used printer in the past, and which is in the list created in Step 415.

Then in Step 417, CPU 1 modifies the print ticket included in the spooled XPS format file depending on the printing error and a capability of a newly selected printer (redirect printer). Based on the newly selected printer, which is also written in RAM 19, and in Step 418, CPU 1 reads the modified print data 424 with print ticket data written in RAM 2 to submit the modified print job to the newly selected printer. Then the program is ended.

FIG. 5 illustrates a detailed flow chart where the redirecting filter is arranged after the layout filter 406 and before the other filter which is device dependent, such as a color management filter, water mark adding filter, etc. When redirecting filter is placed after the layout filter 406 and before the other filters which are device dependent, it is more straightforward as in conventional spooled data.

In FIG. 5, the blocks or steps having the same number has the same function as those in FIG. 4. As shown in FIG. 5, 504 denotes the print filter pipeline wherein the output of the layout filter 406 is supplied to other filters 507, which are device independent, and the then supplied to the redirect filter 405, which is located before the other filters 407. Therefore, the redirect module 512 does not need Step 425 as in FIG. 4.

In FIG. 5, when redirect module is launched, Step 413 starts reading the XPS print data 420 and start modifying print job data for remaining pages as shown in FIG. 6, and then in Step 414 prioritizing print setting based on the remaining FPs, FDs and print setting that influences most on the job or document scope.

FIG. 6 illustrates a flowchart for job modification process, which corresponds to Step 413 in FIGS. 4 and 5, where the print job is being modified, when XPS filter is inserted as a first filter of the XPS driver. In the following embodiment, technical terms are defined in the document, “Print Schema Specification, Print Schema Reference Guide, Version 1.0”, by Microsoft Corporation. In Step 601, job modification process starts, wherein JobCollate denotes psk:JobCollateDocuments, DocCollate denotes psk:DocumentCollate, whose possible values are :psk:collated or psk:uncollated, JobCopy denotes psk:JobCopiesAllDocuments, and DocCopy denotes psk:DocumentCopyAllPages. In Step 602, the algorithm first checks JobCollate setting of the Job. If JobCollate is not uncollated, then the flow proceeds to Step 604.

If JobCollate is uncollated in Step 602, then in Step 603, Doc Copy is set to JobCopy multiplied by DocCopy. Then, the algorithm proceeds to Step 604. However, another embodiment is to either wait for an entire job to be spooled and analyze the print setting of the entire job and provide to select a printer, or redirect the job as soon as error occurred based on the print settings available at that time.

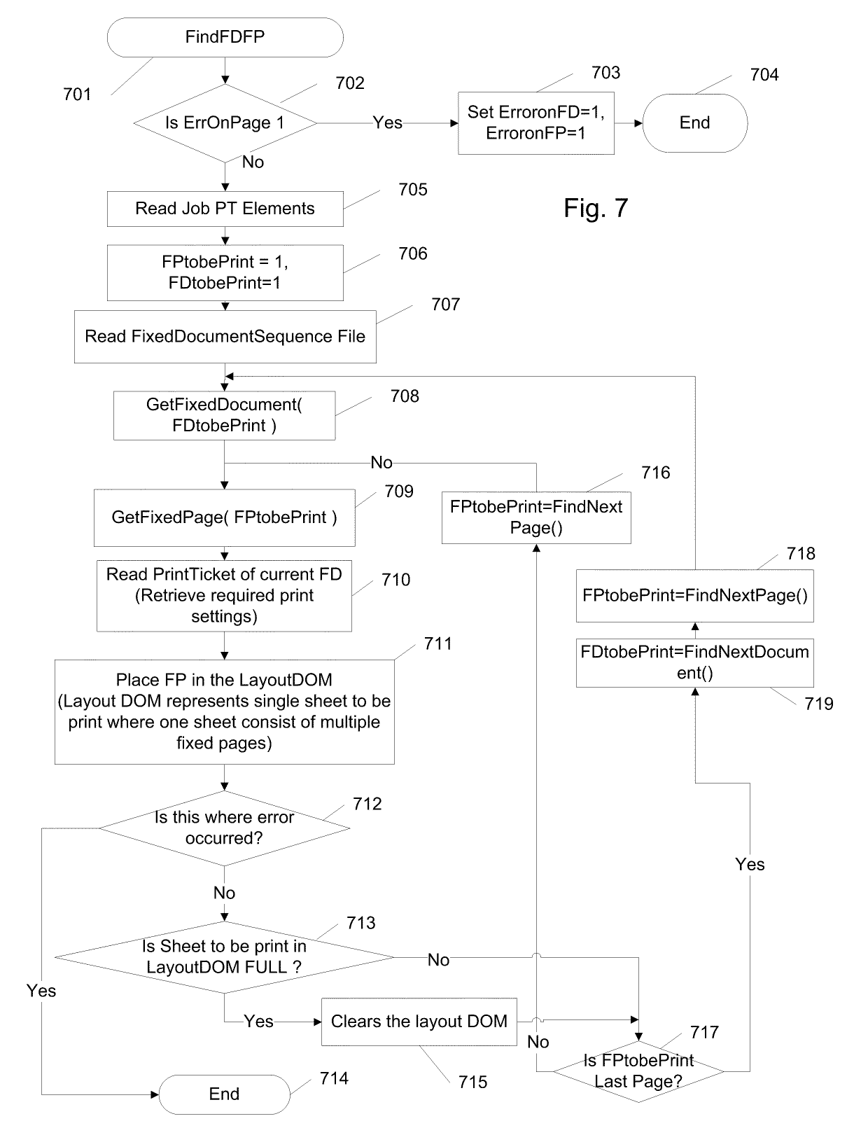

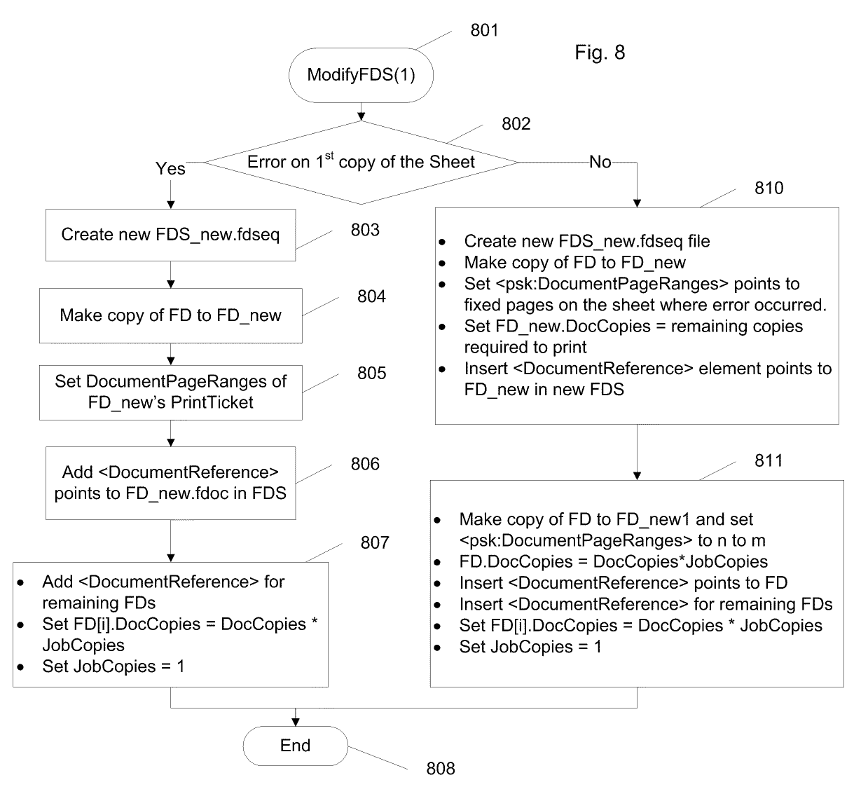

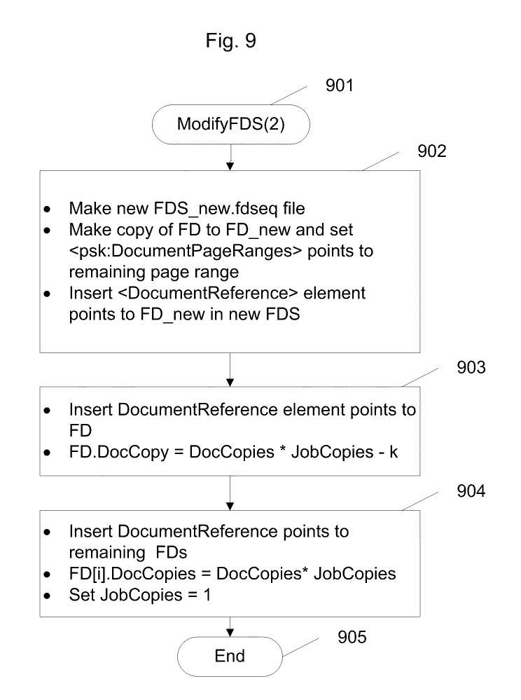

In Step 604, Algorithm calls FindFDFP (See FIG. 7) and finds out the specific FixedDocument(FD) and FixedPage(FP) where an error occurred. Then, Step 605 further checks collate option of the FD, if it is uncollated, it calls ModifyFDS(1) in Step 606, (See FIG. 8), otherwise calls ModifyFDS(2) in Step 607, (See FIG. 9). This modification process modifies the fixed document sequence(FixedDocumentSequence.fseq) FDS part and generates appropriate XPS spool date to be print, then proceeds to Step 608 to end.

In Step 604, FindFDFP process as shown in FIG. 7 traverses each <DocumentReference> element in the FDS and traverses each <PageContent> element in the FP as well as applying effective print setting and find out in which FD and FP error occurred. It includes various pint settings DocumentNup, DocuentNupContiguous, Duplex and other settings.

The job modification process shown in FIG. 6 can handle both cases: having redirect filter before the layout filter or after layout filter. Here, Job modification can be done in two different way: (1) removing page reference elements from FD and not passing those pages (2) by generating the print ticket with <psk:DocumentPageRanges> parameters, which describe the pages or range of pages within the associated document of the print job to output.

When a filter is placed after the layout filter and just above the device specific filter (as in FIG. 5), modification of the XPS job is straightforward than the previous case because every page represents the front or back side of the printable sheet, so the Job modification process may not do pseudo page layout process to find out where the error occurred.

However, it must handle JobCopy (psk:JobCopiesAllDocuments), DocumentCopy(psk:DocumentCopyAllPages) count as well as JobCollate (psk:JobCollateDocuments), DocumentCollate(psk:DocumentCollate)settings. Herein, psk stands for Print Scheme Keyword. Those and other XPS related words used in this specification are defined in the “Print Schema Specification, Print Schema Reference Guide, 2007 Microsoft Corporation.”

Also when redirect filter is inserted after layout filter, in this embodiment, job modification process undoes device specific operation that has been performed in the layout filter so that proper job modification is carried out. Job Modification process is dependent on various print features: Copy, Collate, N-UP, Duplex, Booklet printing, and reverse printing. This embodiment describes the collate and copy print ticket settings that specify the order in which copies of documents and pages are output.

Following XPS print settings are used to describe the copy and collate features:
psk:JobCopiesAllDocuments—specifies the number of times that all documents within the print job are output.
psk:DocumentCopiesAllPages—specifies the number of copies of the associated document in the print job to output.
psk:PageCopies—specifies how many copies of an individual source document page within a document should be output.

Take this example:

FDS-> FD1, FD2, JobCopiesAllDocuments = 3,
FD1.DocumentCopyAllPages = 2, FD2.DocumentCopyAllPages = 2

| JobCollateDocuments | DocumentCollate | Behavior |
|---|---|---|
| psk:Collated | Psk:Collated | (FD1 + FD1 + FD2 + FD2) × |
| | | 3 times |
| Psk:Collated | psk:Uncollated | FD1(P1 − P1, P2 − P2 . . . ) − |
| | | FD2(P1 − P1, P2 − P2) × 3 |
| | | times |
| psk:UnCollated | Psk:Collated | FD1 × [2(DocCopy) × |
| | | 3(JobCopy)] + FD2 × |
| | | [2(DocCopy) × 3(JobCopy)] |
| Psk:uncollated | Psk:Uncollated | FD1( P1 − P1 − P1 − P1 − |
| | | P1 − P1, P2 (×6) . . . ) + |
| | | FD2(P1(×6) + P2(×6) . . . ) |

Dependent upon the settings specified in the psk:JobCollateAllDocuments Feature and in the psk:DocumentCollate Feature and settings specified in psk:JobCopiesAllDocuments Feature and DocumentCopiesAllPages Feature the sheet output order SHOULD be as follows:

When the psk:Uncollated Option of the psk:JobCollateAllDocuments Feature and the psk:Collated Option of the psk:DocumentCollate Feature are specified in the selected settings, each document in the job SHOULD be output the number of times specified by the psk:DocumentCopiesAllPages Parameter initializer of the Document's selected settings multiplied by the psk:JobCopiesAllDocuments Parameter initializer and collated as specified by the psk:Collated Option of the psk:DocumentCollate feature.

The psk:JobCollateAllDocuments Feature specifies the order in which documents of the print job appear in the printed output. When the psk:Collated Option of the psk:JobCollateAllDocuments Feature and the psk:Collated Option of the psk:DocumentCollate Feature are specified in the selected settings, each document in the job SHOULD be output the number of times specified by the psk:DocumentCopiesAllPages Parameter initializer and collated as specified by the psk:Collated Option of the psk:DocumentCollate Feature. After all Documents have been output the number of times specified by their psk:DocumentCopiesAllPages Parameter initializer, this process SHOULD be repeated until the job has been output the number of times specified by the Feature psk:JobCopiesAllDocuments Parameter initializer.

When the psk:Collated Option of the psk:JobCollateAllDocuments Feature and the psk:Uncollated Option of the psk:DocumentCollate Feature are specified in the selected settings, the first sheet to be printed SHOULD be output the number of times specified by the Feature psk:DocumentCopiesAllPages Parameter initializer. After the first sheet to be printed has been output the number of times specified by the psk:DocumentCopiesAllPages Parameter initializer, each successive sheet of the Document if any SHOULD be output the number of times specified by the psk:DocumentCopiesAllPages Parameter initializer.

After all Documents have been output the number of times specified by their psk:DocumentCopiesAllPages Parameter initializer once, this process SHOULD be repeated until the job has been output the number of times specified by the psk:JobCopiesAllDocuments Parameter initializer. When the psk:Uncollated Option of the psk:JobCollateAllDocuments Feature and the psk:Uncollated Option of the psk:DocumentCollate Feature are specified in the selected settings, the first sheet to be printed SHOULD be output the number of times specified by the psk:DocumentCopiesAllPages Parameter initializer of the Document's selected settings multiplied by the psk:JobCopiesAllDocuments Parameter initializer.

After the first sheet to be printed has been output the number of times specified by the psk:DocumentCopiesAllPages Parameter initializer of the document's Print Ticket Document multiplied by the psk:JobCopiesAllDocuments Parameter initializer each successive sheet SHOULD be output the number of times specified by the psk:DocumentCopiesAllPages Parameter initializer of the document's Print Ticket Document multiplied by the psk:JobCopiesAllDocuments Parameter initializer.

In FIG. 7, FindFDFP process starts from Step 701 to find Fixed Document, Fixed Page where an error occurred and to find the copy page where the error occurred on JobCollate=uncollate. In Step 702, if Error exists on page 1, then going to Step 703, ErrorOnFD is set to 1, and ErroronFP is set to 1, then going to Step 704 to end algorithm.

If Error does not exist on page 1 in Step 702, Job PT (Print Ticket) Element is read in Step 705. In Step 706, FTtobePrint is set to 1, and FDtobePrint is set to 1. In Step 707, FixedDocumentSequenceFile is read. In Step 708, FixedDocument(FDtobePrint) is obtained. In Step 709, FixedPage(FPtobePrint) is obtained. In Step 710, PrintTicket of current FD is read, so that required print setting is retrieved.

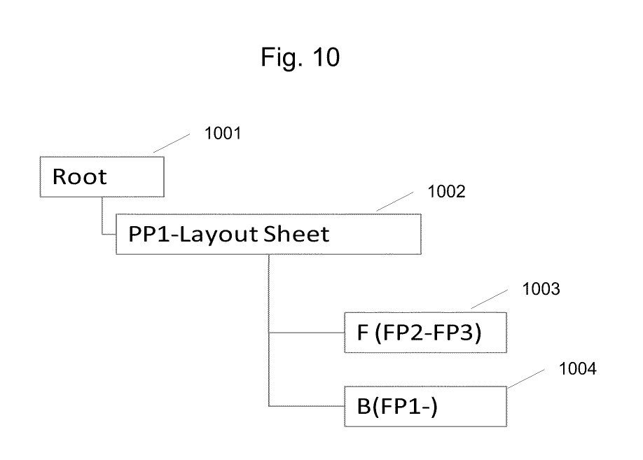

In Step 711, FP is placed in the LayoutDOM, which is shown in FIG. 10, wherein LayoutDOM represents single sheet to be print where one sheet consists of multiple fixed pages. When RedirectFilter is inserted after the layout filter, each fixed page will represent the front or back side of the sheet in layoutDOM. In Step 712, this is where an error occurred is checked, and if yes, that means that the error happened in this FixedPage(FPtobePrint_) and FixedDocument(FDtobePrint), it also finds out whether the error occurred on first copy of the sheet or kth copy of the sheet for document uncollate option. Then it proceeds to Step 714 to end the algorithm.

In Step 713, if Sheet to be print in LayoutDOM is full, then in Step 715, the algorithm clears the layoutDOM. Then the algorithm goes to Step 717 and if FP is not the last page, then in Step 716, FPtobePrint is set to FindNextPage( ), which means it gets the next page (here next page refers to the next page to be placed in the layoutDOM, for booklet printing, next page means not next position of the page in the document), and then going back to Step 709.

However, sometimes same page will be returned based on PageCopies or Document/Job Copy with uncollate options. In Step 712, if Sheet to be print in LayoutDOM is not full and FP is not the last page, then the algorithm proceeds to Step 717.

In Step 717, if FP is the last page, then going to Step 719, and FDtobePrint is set to FindNextDocument( ), using JobCopiesAllDocuments, DocumentCopiesAllPages, JobCollateDocuments, and DocumentCollate to find next fixed document, then going to Step 718 and FPtobePrint is set to FindNextPage( ), using JobCopiesAllDocuments, DocumentCopiesAllPages, JobCollateDocument, and DocumentCollate to find next fixed page, then going back to Step 708.

In FIG. 8, ModifyFDS(1) starts from Step 801, which corresponds to Step 606 in FIG. 6. In FIG. 8, “FD” is Specific Fixed Document where the error occurred, and “n” is a starting position of fixed page affected by the error. “m” is a total number of pages in the document. For booklet printing, it refers to specific fixed pages. In Step 802, if the error exists on the first copy of the sheet, then it goes to Step 803.

In Step 803, a new FDS part (FDS_new.fdseq) is created. Then in Step 804, copy of FD to FD_new is made. Then in Step 805, DocumentPageRanges of FD_new's PrintTicket is set. In Step 806, <DocumentReference> element is added to FDS part that refers (or) points to FD_new.fdoc. In Step 807, <DocumentReference> element is added for remaining FDs. And FD(i).DocCopies is set to DocCopies multiplied by JobCopies, and JobCopies is set to 1.

Then in Step 808, the algorithm is ended. In Step 802, error does not exist on the first copy of the sheet, then in Step 810, new FDS part (FDS_new.fdseq) is created, and copy of FD to FD_new is made. And <psk:DocumentPageRanges> is set to point to fixed pages on the sheet where the error occurred, and FD_new.DocCopies is set to remaining copies required to print(DocCopies setting of a print ticket of FD_new points to remaining copies required to print).

And <DocumentReference> element is inserted to point to FD-new in newly created FDS part (FDS_new.fdseq). Then in Step 811, copy of FD to FD_new1 is made and <psk:DocumentPageRange> is set n to m. And FD.DocCopies is set to DocCopies multiplied by JobCopies. And <DocumentReference> element points to FD is inserted. And <DocumentReference> element for remaining FDs are inserted.

And FD(i).DocCopies is set to DocCopies multiplied by JobCopies. And JobCopies is set to 1. Then it proceeds to Step 808 to end. In FIG. 9, ModifyFDS(2) starts from Step 901, which corresponds to Step 607 in FIG. 6. In FIG. 9, “FD” is Specific Fixed Document where the error occurred, and “n” is a position of fixed page affected by the error.

“m” denotes a total number of fixed pages in the document. Error occurred on k-th copy of the document. For booklet printing, it specifies all the fixed pages. In this process, in Step 902, new FDS part (FDS_new.fdseq) is made, and copy of FD to FD_new.

And <psk:documentPageRanges> points is set to remaining page range. And <DocumentReference> element points to FD_new.fdoc is inserted in new_FDS part (FDS_new.fdseq). In Step 903, DocumentReference element points to FD is inserted, and FD.DocCopy is set to DocCopies multiplied by JbCopies-k. In Step 904, DocumentReference points to remaining FDs is inserted and FD(i).DocCopies is set to DocCopies multiplied by JobCopies. And JobCopies is set to 1. Then it goes to Step 905 to end.

FIG. 10 corresponds to LayoutDom which represents the layout of the sheet to be printed, for booklet printing following three pages making one sheet including front page and back page. LayoutDOM represents the programming model of the printable sheet to be print. It has one sheet node with front and back side (for duplex, in simplex only one side); each side consists of one more fixed pages based on the print settings. When 2-up with duplex or booklet binding, it represents each fixed pages placed in one side.

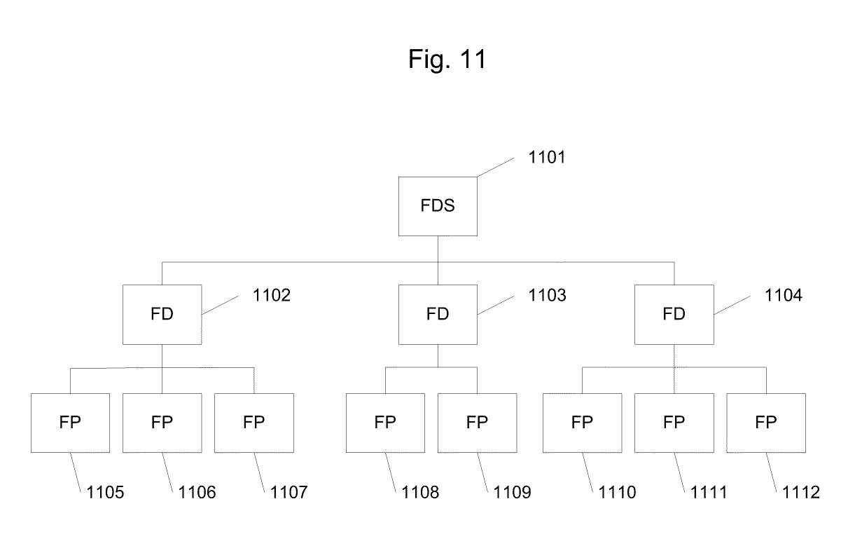

In FIG. 10, 1001 denotes a root directory, 1002 denotes PP1-Layout Sheet, under which F (Front page) 1003 and B (Back Page) 1004 is located. FIG. 11 shows XPS DOM, wherein 1101 denotes Fixed Documents, 1102 denotes Fixed Document 1 with PrintTicket:Booklet printing, 1103 denotes Fixed Document 2 with a PrintTicket: Double, 1104 denote Fixed Document 3. 1105 to 1112 denote Fixed Pages.

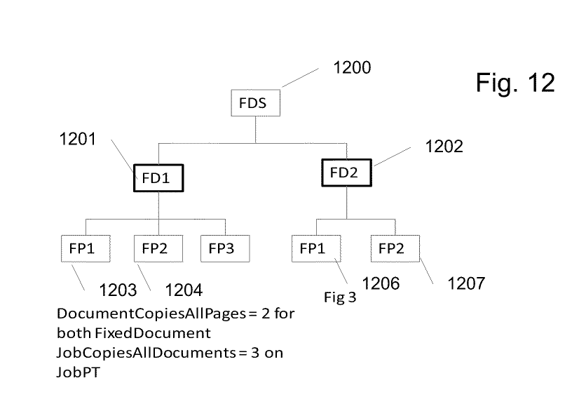

FIG. 12 shows another structure of Fixed document, wherein 1201 denotes Fixed Document 1, and 12 2 denotes Fixed Document 2, and 1203 to 1207 denote Fixed Pages. Here, DocumentCOpiesAllPages is set to 2 for both FixedDocument and JobCopiesAllDocuments is set to 3 on JobPT.

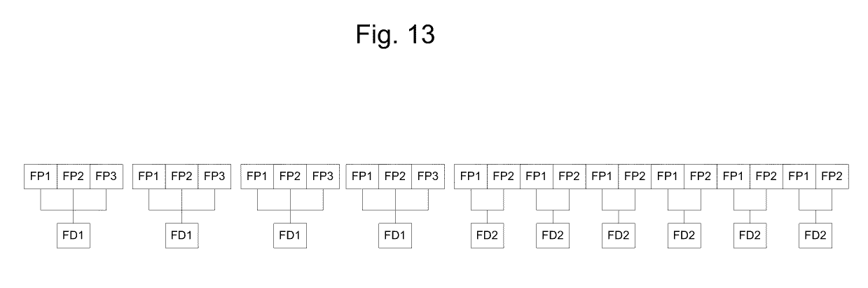

FIG. 13 shows job modification example of XPS document with two fixed document and various copy count settings, wherein JobCollateDocument::UnCollated, DocumentCollate::Collated, Whole Job is printed in three times, DocumentCopiesAllPages is set to two and JobCopiesAllDocument is set to three. In FIG. 13, when the error occurs on FP2 on the second copy of the FD1, the algorithm of this embodiment will update the FDS and generate following XPS document.

For Booklet printing, this method returns a list of fixed pages that are already printed along with position of FP where the error occurred. Also it handles accordingly for reverse printing that remaining pages will be calculated from beginning of the document to the error page.

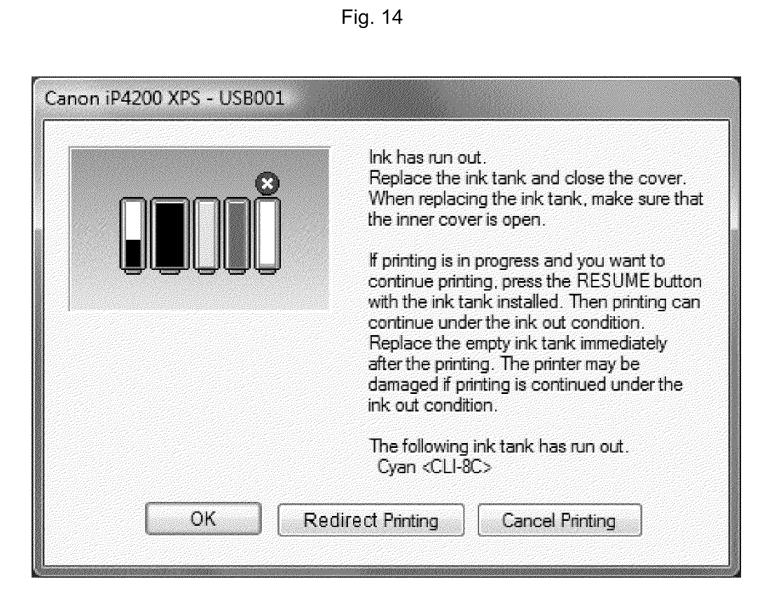

FIGS. 14 to 16 show Graphical User Interfaces, wherein FIG. 14 shows redirection UI in Status Monitor when the error occurs.

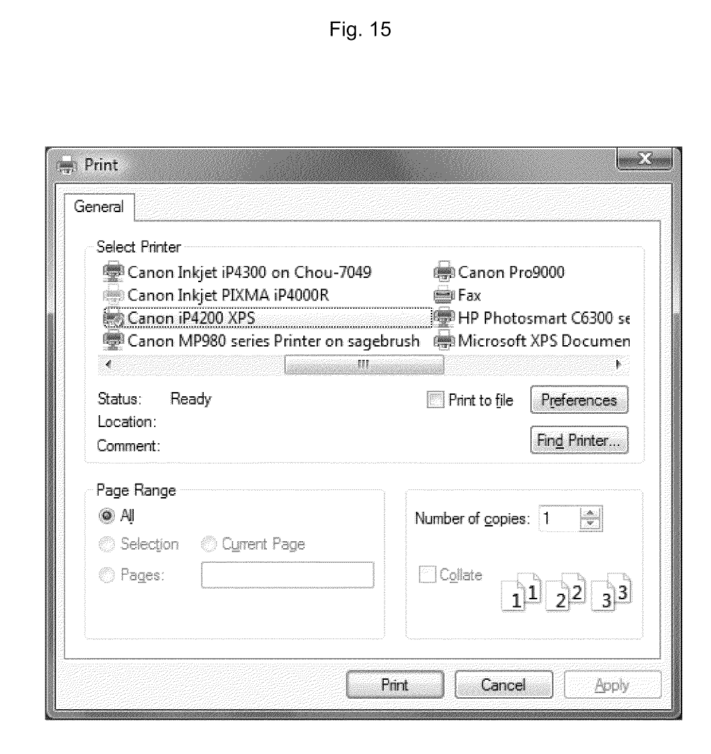

FIG. 15 shows target printer selector UI when “redirect printing” is selected in FIG. 14.

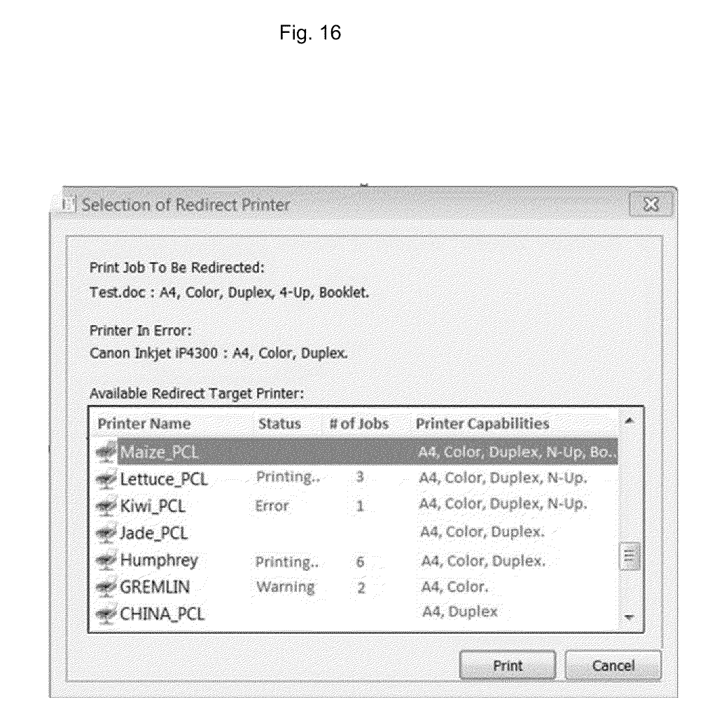

FIG. 16 shows another example of target printer selector UI which can show detailed property of printers so that use can select an appropriate printer.

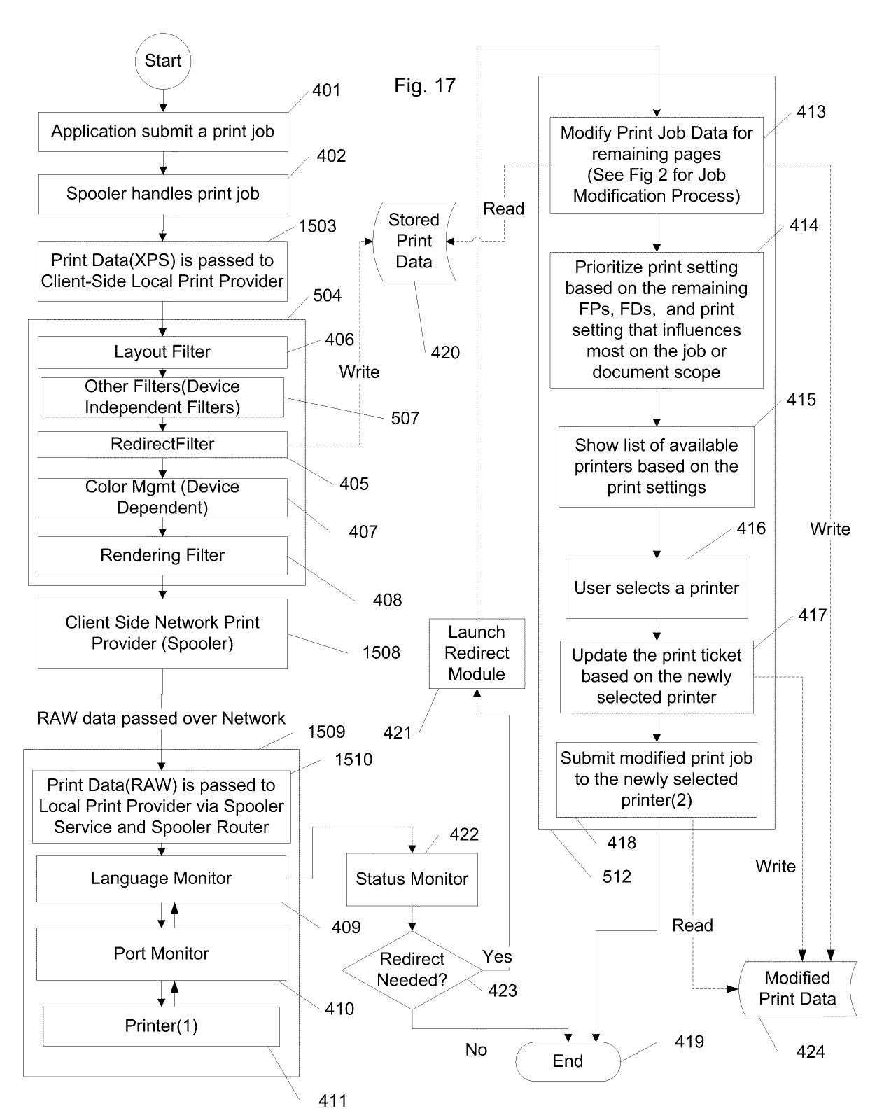

FIG. 17 illustrates a detailed flow chart for showing a redirection process according to an exemplary embodiment relating to a printing system under point and print client-server printing environment.

In the past technology, when redirecting spooled file on error, if the printing system is working with CSR (client side rendering) under client-server printing environment, it is not possible to redirect spooled data when the client driver creates RAW data from the spooled file and the RAW data is sent to the server because the original spooled file is deleted once the job is sent to the server.

However, according to this embodiment, as the driver saves the copy of the spooled data, it is possible to redirect saved spool file with modification to other devices to properly complete the print job.

In FIG. 17, the blocks or steps having the same number have the same function as those in FIGS. 4 and 5. In FIG. 17, block 1509 denotes a server side, while other blocks or Steps are included in a client side, where the redirect application runs. The server side has a hardware structure similar to that of the client computer 4000 shown in FIG. 1 and a CPU and a memory in the server side works to carry out the server side program steps.

In Step 1503 the XPS print data is passed to Client-Side Local Print Provider. In Step 1508, RAW data from Step 408 is received in the Client Side Network Print Provider, then passed to the server side 1509 over the network.

In Step 1510, the XPS print data is passed to Local Print Provider via Spooler Service and Spooler Router, then sent to Language Monitor 409. According to the present embodiment, for example, printer driver is installed on the client computer side, by double clicking print queue on the server and client side rendering is set by default.

The printer driver installed on the client side will process the print data and convert to a printer specific RAW data in Step 408, which will be sent to server side print spooler 1510, which takes RAW data and sends it to print device through port monitor 410. The driver at the local client side caches entire XPS print data 420, before converting it into RAW data in Step 408.

Status monitor 422 is, for example, a DLL launched as a separate process by rundll32.exe which indicates status of the job by communicating with the device through bi-directional communication. The Status monitor 422 and other driver component (one of the XPS Filter, for example, in XPSDrv Driver) communicate with each other through the inter process communication channel.

XPS Filter saves entire spooled print data 420 at some point but before converting to the RAW data. Status monitor 422 will be launched and keep monitoring the print job, when the print job fails due to device fault, it will ask the user for redirection in Step 423, if the user selects “Yes”, a request for redirect printing is sent to Step 421. Step 421 will cancel the current job and launch the redirect module application 512 with the (cached) XPS print data including other details.

Redirect module 512 submits a request to the memory where the XPS print data is stored and in response to the request, the stored XPS print data 420 is sent to the redirect module. The redirect module analyzes cached print data (print settings and print content—some of these features are possible when XPS data is used as the spool data) and shows the list of printers in Step 415 for the print job. When the printer is selected, it regenerates new print data file in Step 417 and submits as a new job in Step 418.

For XPSDry case, as shown in this embodiment, the redirect filter is placed after the layout filter and before the rendering filter, so that it saves XPS Document after applying all the layout operations. It would eliminate performing layout operation again. In FIG. 17, as explained, the solution will work on the point-and-print scenario with client side rendering.

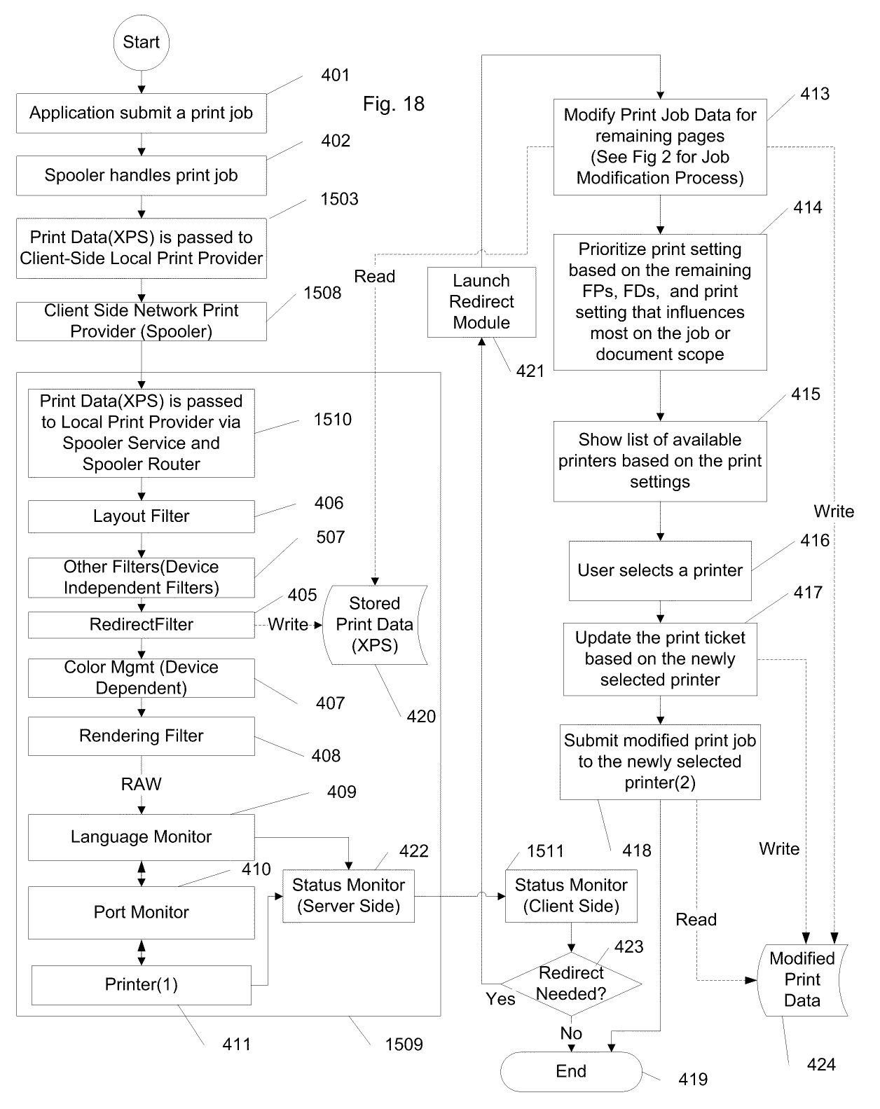

FIG. 18 illustrates a detailed flow chart for showing another redirection process according to another exemplary embodiment, wherein server-side rendering is achieved by the redirect filter in the server side 1509 passing data back to the client side status monitor through distributed component object model.

In FIG. 18, the blocks or steps having the same number have the same function as those in other figures. 422 denotes a Status Monitor, which is in the Server side. 1511 denotes a Status Monitor, which is in the Client side. As shown in FIG. 18, rendering process is carried out in the Server side.

XPS data 420 is stored while being converted to the RAW data in step 408. When an error occurs during printing, the Status Monitor 422 detects it and sends the information to the Status Monitor 1511 in the Client side.

When the redirect is needed, the redirect module is launched by Step 421 and Step 413 reads the stored XPS print data. Therefore, according to the present embodiment, even in the point and print client-server printing environment, universal XPS data is utilized and proper redirect printing is realized.

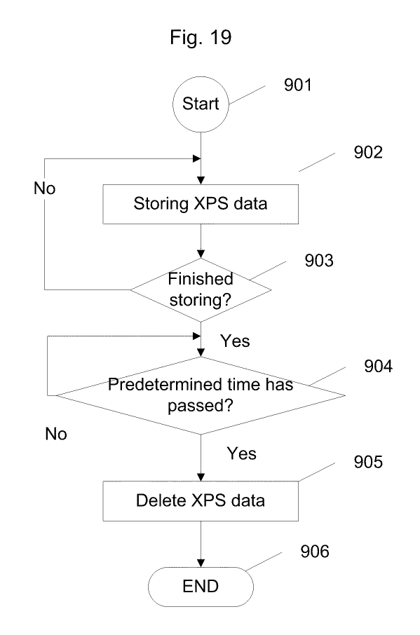

FIGS. 19 to 22 illustrate embodiments for deleting the XPS print data stored in the memory, wherein those embodiments could be applicable to various embodiments explained before. For example, if those deletion processes are applied to the embodiment shown in FIG. 17, then the CPU and memory in the client side will control the deletion process. On the contrary, if they are applied to the embodiment shown in FIG. 18, the CUP and memory in the server side will control the deletion process.

In FIG. 19, the deletion process starts in Step 901. In Step 902, the XPS print data 420 is written in the memory, then the CPU detects that the data storing is finished in Step 903. After finishing storing the data, the data is stored for a predetermined time period, so that the redirect module can read out the data if launched. However, if the predetermined time, such as 30 minutes, has passed in Step 904, from finishing storing the XPS print data 420, then the XPS print data is automatically deleted in Step 905. Then the program ends in Step 906.

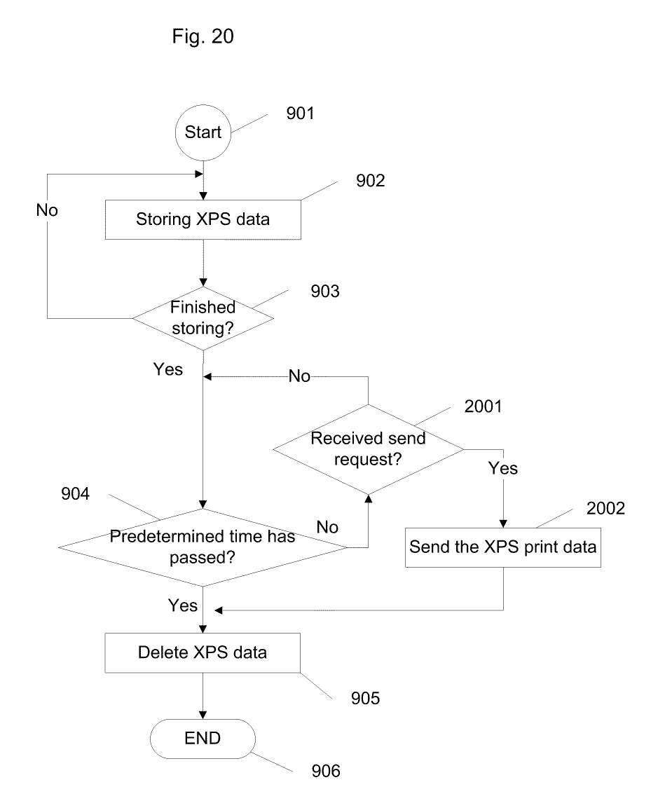

FIG. 20 illustrates another embodiment for deleting the XPS print data. The same Step numbers as those in FIG. 19 denote the same functional Step. In step 2001, the CPU detects whether it received a request to send the XPS print data 420 to the redirect module, and if yes in Step 2001, then the CPU sends the data to the redirect module in Step 2002, then delete the data in Step 905. If there is not the request to send in Step 2001, and if the predetermined time has passed in Step 904, then the XPS print data 420 is deleted in Step 905. By the way, Step 2001 could be replaced by a step for detecting whether the redirect module is launched or not.

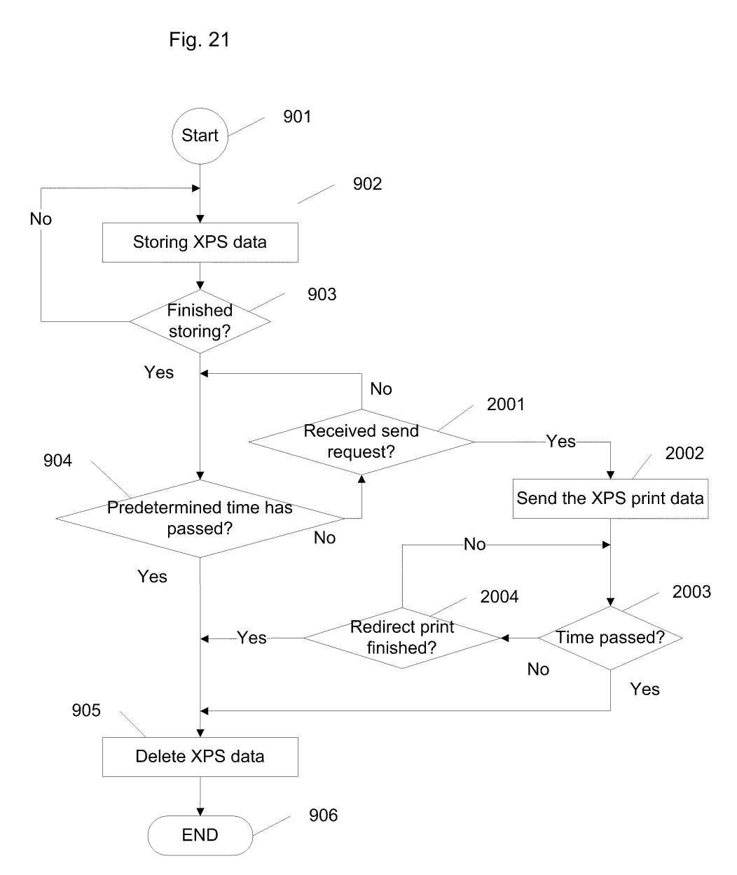

FIG. 21 illustrates another embodiment for deleting the XPS print data 420, wherein the same Step numbers as those in FIGS. 19 and 20 denote the same functional Step. In Step 2003, the CPU starts a redirect printing timer in response to the sending the XPS print data to the redirect module, and if predetermined time, for example 45 minutes, has passed, then the CPU deletes the XPS print data 420 in Step 905. If the redirect printing is finished in Step 2004 before the predetermine time for the redirect printing has passed, then the CPU deletes the XPS print data 420 in Step 905.

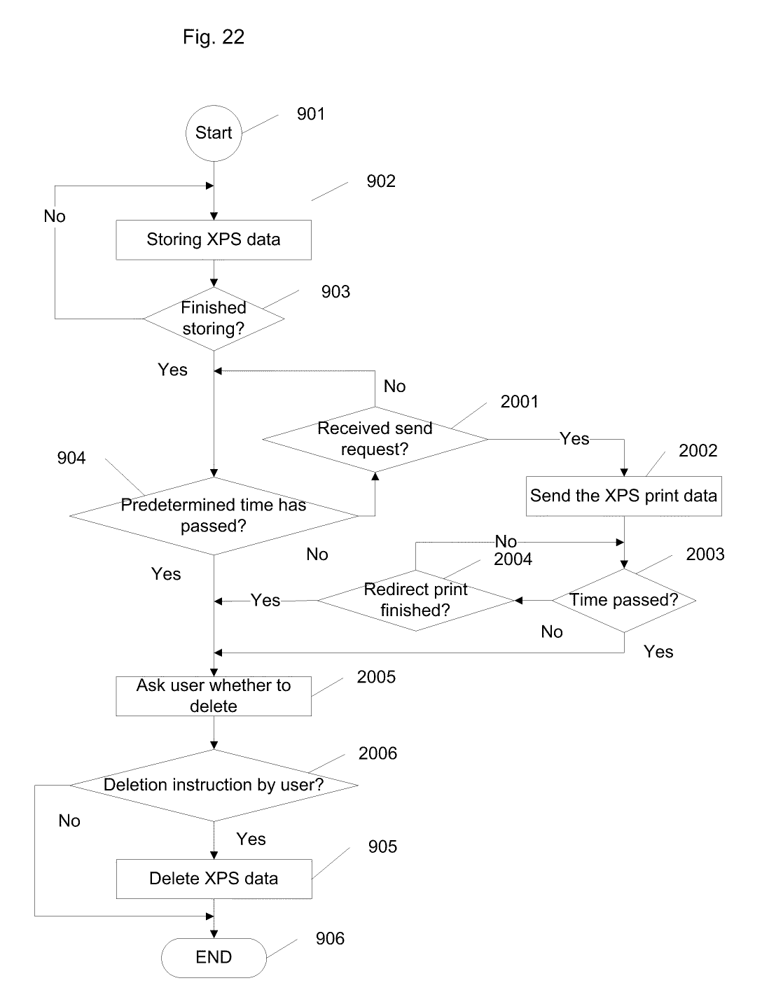

FIG. 22 shows another embodiment for deleting the XPS print data, wherein the CPU in the server side and/or the client side computer makes the display connected to the client side computer to show a dialog to ask users whether XPS print data should be deleted or not in Step 2005. Then in Step 2006, the CPU in the server side and/or the client side computer detects whether the user chooses deletion or not. If yes in Step 2006, then the XPS print data 420 is deleted in Step 905. If not in Step 2005, then the program ends in Step 906. After Step 906, by turning off the power of the server side and/or the client side computer, which is controlling the XPS print data 420, the XPS print data 420 disappears.

Another example of this invention is as follows, when an error occurred on specific page, it determines the logical page number and new spool files is generated based on the following method: it first obtains the Job Print ticket of the spool file which will be merged and validated with redirecting target printer; it will yield new job print ticket for the new redirecting job, same process is performed for document print ticket of the remaining document as well as the page print ticket of remaining pages; now, new spool file is generated based on the newly generated print tickets, also making changes to fixed document, fixed page, and other parts of the spool file based on the settings.

Special cases, such as a replacing color profile with color profile of the redirecting target printer, are also handled in this method.

While currently available techniques are based on a print driver provided the binary DEVMODE or pre-configured knowledge base containing supported print settings of known printers in the network. So, it has limitations, such as, device selection includes only specific IHV printers (dependent on specific PDL) or pre-configured network printers on cluster printing environment, it allows limited device selection since private part of the DEVMODE is not accessible by other hardware vendors, it is unable to provide device selection from ad-hoc/mobile printing environment (work versus home printing scenarios), it only supports for newly installed printers (When a new printer is installed, pre-configuration must be updated), according to these embodiments, the above problems are greatly improved.

Therefore, it is possible to handle ad-hoc network/printing environment (work versus home printing scenarios), it is possible to produce better print result and quality because of wider accessibility of print settings, it is possible to apply color correction for remaining pages using redirect printer's color profile settings, etc.

As one of the embodiments, a storage medium storing a software program code for realizing the functions of the above-described exemplary embodiments can be supplied to a system or an apparatus. A computer (or CPU or micro-processing unit (i.e., MPU)) in the system or the apparatus can read the program code from the storage medium and execute the program code to realize the functions of the above-described exemplary embodiments.

In this case, the program code itself read out of the storage medium can realize novel functions of the present invention. The storage medium storing the program code constitutes the present invention.

Accordingly, equivalents of programs (e.g., object code, interpreter program, and OS script data) are usable if they possess comparable functions.

A storage medium supplying the program can be selected from any one of a floppy disk, a hard disk, an optical disk, a magneto-optical (i.e., MO) disk, a compact disc-ROM (i.e., CD-ROM), a CD-recordable (i.e., CD-R), a CD-rewritable (i.e., CD-RW), a magnetic tape, a nonvolatile memory card, a ROM, and a digital versatile disc (i.e., DVD (including a DVD-ROM and a DVD-R)).

In this case, the program code itself read out of the storage medium realizes the functions of the above-described exemplary embodiments. The storage medium storing the program code constitutes the present invention.

The method for supplying the program includes accessing a website on the Internet using the browsing function of a client computer, when the website allows each user to download the computer program of the present invention, or compressed files of the programs having automatic installing functions, to a hard disk or other recording medium of the user. Furthermore, the program code constituting the program of the present invention is dividable into a plurality of files so that respective files are downloadable from different websites. Namely, the present invention encompasses World Wide Web (i.e., WWW) servers and File Transfer Protocol (i.e., FTP) servers that allow numerous users to download the program files so that their computers can realize the functions or processes according to the present invention.

Moreover, enciphering the program according to the present invention and storing the enciphered program on a CD-ROM or comparable storage medium is an exemplary method when the program of the present invention is distributed to users. The authorized users (i.e., users satisfying predetermined conditions) are allowed to download key information from a website on the Internet. The users can decipher the program with the obtained key information and can install the program on their computers.

When the computer reads and executes the installed program, the computer can realize the functions of the above-described exemplary embodiments. Moreover, an operating system (i.e., OS) or other application software running on a computer can execute part or all of actual processing based on instructions of the programs to realize the functions of the above-described exemplary embodiments.

Additionally, the program code read out of a storage medium can be written into a memory of a function expansion board inserted in a computer or into a memory of a function expansion unit connected to the computer. In this case, based on instructions of the program, a CPU provided on the function expansion board or the function expansion unit can execute part or all of the processing to realize the functions of the above-described exemplary embodiments.

According to the exemplary embodiments of the present invention, the structure of a job whose print processing is suspended can be corrected to a state where the print can be instructed to resume from a breakpoint or restart from the beginning.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

What is claimed is:

1. A method for controlling a printer via a server computer, comprising:
spooling a file including a hierarchy of a print ticket attached with a fixed document and a fixed page, in response to a print job on a client computer;
creating print data from a spooled file;
processing a print job;
storing, using a CPU, a copy of the spooled file during the processing of the print job;
receiving a request to redirect; and
sending a modified copy of the spool file to another printer after the request to redirect is received.

2. A method according to claim 1, wherein the spooled file is created in an XPS format.

3. A method according to claim 1, wherein the request for redirecting is received in response to printing error detection by the server computer.

4. A method according to claim 1, wherein the copy of the spooled file is modified based on the information about the page where an error occurred.

5. A method according to claim 1, wherein the print data is created in a RAW format.

6. A method for controlling a printer via a server computer, comprising:
spooling a file including a hierarchy of a print ticket attached with a fixed document and a fixed page, in response to a print job on a client computer;
creating print data from a spooled file;
processing a print job;
storing, using a CPU, a copy of the spooled file during the processing of the print job;
receiving a request to redirect;
sending a modified copy of the spooled file to another printer after the request to redirect is received; and
deleting the copy of the spooled file if a signal which corresponds to a predetermined redirect printing operation is not received.

7. A method according to claim 6, wherein the request for redirecting is submitted in response to printing error detection.

8. A method according to claim 6, wherein the spooled file is created in an XPS format.

9. A method according to claim 6, wherein the print data is created in a RAW format.

10. A system for controlling a printer via a server computer, comprising:
spooler for spooling a file including a hierarchy of a print ticket attached with a fixed document and a fixed page, in response to a print job on a client computer;
rendering unit for creating print data from a spooled file;
processing unit for processing a print job;
storing unit for storing a copy of the spooled file during the processing of the print job;
receiving unit for receiving a request to redirect; and
sending unit for sending a modified copy of the spooled file to another printer in response to the request to redirect.

11. A printer according to claim 10, wherein the spooled file is created in an XPS format.

12. A printer according to claim 10, wherein the request for redirecting is submitted on printing error detection by the server computer.

13. A printer according to claim 10, wherein the spooled file is modified based on the information about the page where the error occurred.

14. A printer according to claim 10, wherein the print data is created in a RAW format.

15. A non-transitory computer readable storage medium which stores a program for controlling a printer via a server computer, wherein the method comprising:
spooling a file including a hierarchy of a print ticket attached with a fixed document and a fixed page, in response to a print job on a client computer;
creating print data from a spooled file;
processing a print job;
storing, using a CPU, a copy of the spooled file during the processing of the print job;
receiving a request to redirect; and
sending a modified copy of the spooled file to another printer in response to the request to redirect.
